(19) United States
(12) Patent Application Publication
(10) Pub. No.: US 2011/0248958 A1
(43) Pub. Date: Oct. 13, 2011

(54) HOLOGRAPHIC BASED OPTICAL TOUCHSCREEN

(75) Inventors: Russell Gruhlke, Milpitas, CA (US); Ion Bita, San Jose, CA (US)

(73) Assignee: QUALCOMM MEMS Technologies, Inc., San Diego, CA (US)

(21) Appl. No.: 12/756,550

(22) Filed: Apr. 8, 2010

(51) Int. Cl. G06F 3/042; H01J 9/00

(52) U.S. Cl. 345/175; 445/24

(57) ABSTRACT

Disclosed are various embodiments of a holographic based optical touchscreen and methods of configuring such devices. In certain embodiments, a touchscreen assembly can include a holographic layer configured to receive incident light and turn it into a selected direction to be transmitted through a light guide. The holographic layer can be configured to accept incident light within an acceptance range and so that the selected direction is within some range of directions so as to allow determination of incidence location based on detection of the turned light. A light source can be provided so that light from the source scatters from an object such as a fingertip near the holographic layer and becomes the incident light. Thus the determined incidence location can represent presence of the fingertip at or near the incidence location, thereby providing touchscreen functionality. Non-limiting examples of design considerations and variations are disclosed.

### BACKGROUND

1. Field

The present disclosure generally relates to the field of user interface devices, and more particularly, to systems and methods for providing holographic based optical touchscreen devices.

2. Description of Related Technology

Certain user interface devices for various electronic devices typically include a display component and an input component. The display component can be based one of a number of optical systems such as liquid crystal display (LCD) and interferometric modulator (IMOD).

In the context of certain display systems, electromechanical systems can include devices having electrical and mechanical elements, actuators, transducers, sensors, optical components (e.g., mirrors), and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers or that add layers to form electrical and electromechanical devices. One type of electromechanical systems device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

The input component typically includes a screen with some contact sensing mechanism configured to facilitate determination of location where contact is made. Such contacts can be made by objects such as a fingertip or a stylus.

### SUMMARY

In certain embodiments, the present disclosure relates to a screen assembly for an electronic device. The screen assembly includes a display device configured to display an image by providing signals to selected locations of the display device. The screen assembly further includes an input device disposed adjacent the display device and configured to detect location of an input. The input location is coordinated with the image on the display device so as to facilitate user interaction with the electronic device. The input device includes a holographic layer configured to receive incident light and direct the incident light towards one or more selected directions. The screen assembly further includes a detector configured to detect the directed light, with detection of the directed light being along the one or more selected directions allowing determination of incidence location on the holographic layer of the incident light.

In certain embodiments, the screen assembly can further include one or more light sources configured to provide light to an object positioned on or near the holographic layer, such that at least a portion of the provided light scatters from the object to yield the incident light on the holographic layer. Such one or more light sources can be configured such that the provided light is distinguishable from ambient light when detected by the detector.

In certain embodiments the present disclosure relates to a touchscreen apparatus having a holographic layer configured to receive incident light and direct the incident light towards a selected direction. The apparatus further includes a light guide disposed relative to the holographic layer so as to receive the directed light from the holographic layer and guide the directed light towards an exit portion of the light guide. The apparatus further includes a segmented detector disposed relative to the light guide so as to be able to detect the directed light exiting from the exit portion so as to facilitate determination of a location of the incident light along at least one lateral direction on the holographic layer.

In certain embodiments, the touchscreen apparatus can further include a light source disposed relative to the holographic layer and configured to provide light to an object positioned on or near the holographic layer, such that at least a portion of the provided light scatters from the object to yield the incident light on the holographic layer. In certain embodiments, the touchscreen apparatus can further include a display, a processor that is configured to communicate with the display, with the processor being configured to process image data, and a memory device that is configured to communicate with the processor. In certain embodiments, the display can include a plurality of interferometric modulators.

In certain embodiments the present disclosure relates to a method for fabricating a touchscreen. The method includes forming a diffraction pattern in or on a substrate layer defining a plane and having first and second sides, with the diffraction pattern configured such that a light ray incident at a selected angle on the first side of the substrate layer is diffracted into a turned ray that exits on the second side of the substrate layer along a direction having a selected lateral component parallel with the plane of the substrate layer. The method further includes coupling the substrate layer with a light guide layer that defines a plane substantially parallel to the plane of the substrate layer, with the light guide layer being on the second side of the substrate layer and configured to received the turned light exiting from the substrate layer and guide the turned light substantially along the direction.

In certain embodiments the present disclosure relates to an apparatus having means for displaying an image on a display device by providing signals to selected locations of the display device, and means for detecting a location of an input on a screen. The input location is coordinated with the image on the display device, with the input resulting from positioning of an object at one or more levels above the screen such that light scattered from the object enters the screen at the location.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 shows that in certain embodiments, an interface device can include a display device and an input device.

FIG. 9A shows a side view of an example embodiment of the input device having a holographic layer and a light guide.

FIG. 9B shows a partial cutaway plan view of the input device of FIG. 9A.

FIGS. 10A and 10B show plan and side views of an example embodiment of the input device configured to detect presence of an object such as a fingertip above the holographic layer.

FIGS. 11A and 11B show that in certain embodiments, selected light rays reflected from the object can be incident on and be accepted by the holographic layer and be directed in one or more selected directions so as to allow determination of incidence location.

FIG. 12 shows that in certain embodiments, the holographic layer can be configured so as to have different selective directional properties at different incidence locations.

FIG. 13 shows that in certain embodiments, the holographic layer can be configured so as to have different diffraction angles at different incidence locations.

FIG. 14 shows that in certain embodiments, detection of light emerging from the light guide can be configured to obtain spatial information contained in angular distribution of light guided through the light guide.

FIGS. 15A-15C show that in certain embodiments, presence of an object such as a fingertip can be detected at a number of levels above the holographic layer.

FIG. 16 shows an example of how detections at the number of levels can yield 3-dimensional position information for the object.

FIG. 17A shows an example of a process that can be implemented to generate an input for the interface device of FIG. 8 based on the 3-dimensional position information.

FIG. 17B shows another example of a process that can be implemented to generate an input for the interface device of FIG. 8 based on the 3-dimensional position information.

FIG. 17C shows an example of a process that can be implemented to facilitate calibration of the interface device.

FIG. 18 shows a block diagram of an electronic device having various components that can be configured to provide one or more features of the present disclosure.

### DETAILED DESCRIPTION

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In certain embodiments as described herein, a display device can be fabricated using one or more embodiments of interferometric modulators. At least some of such modulators can be configured to account for shifts in output colors when the display device is viewed at a selected angle so that a desired color output is perceived from the display device when viewed from the selected angle.

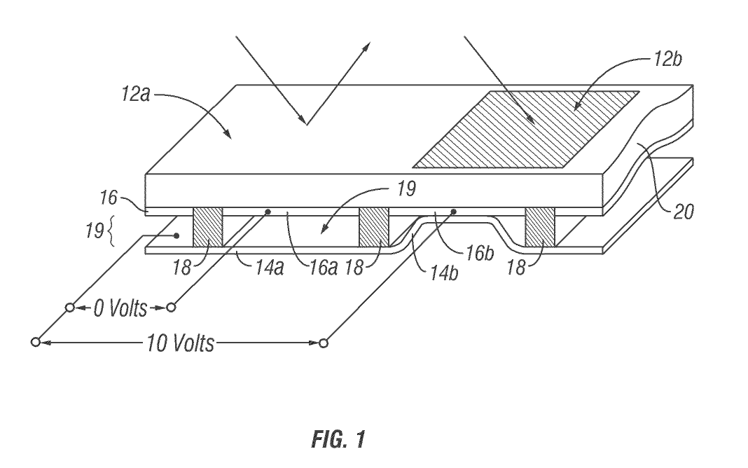

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

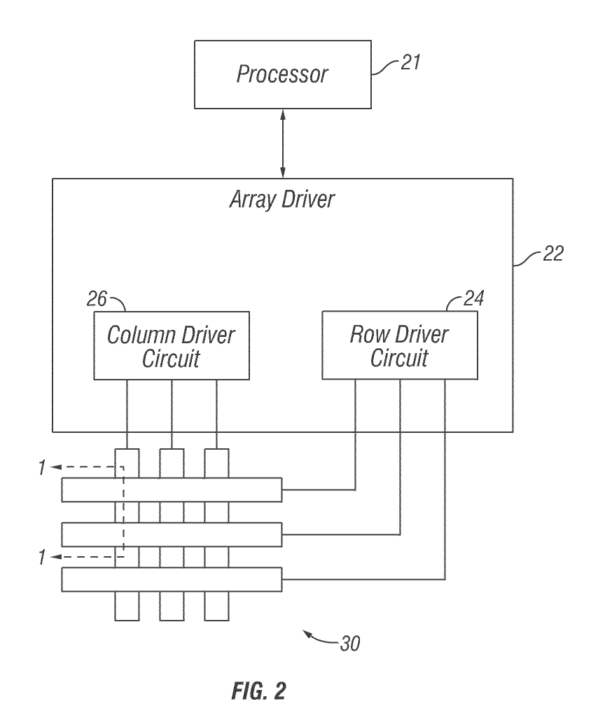

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

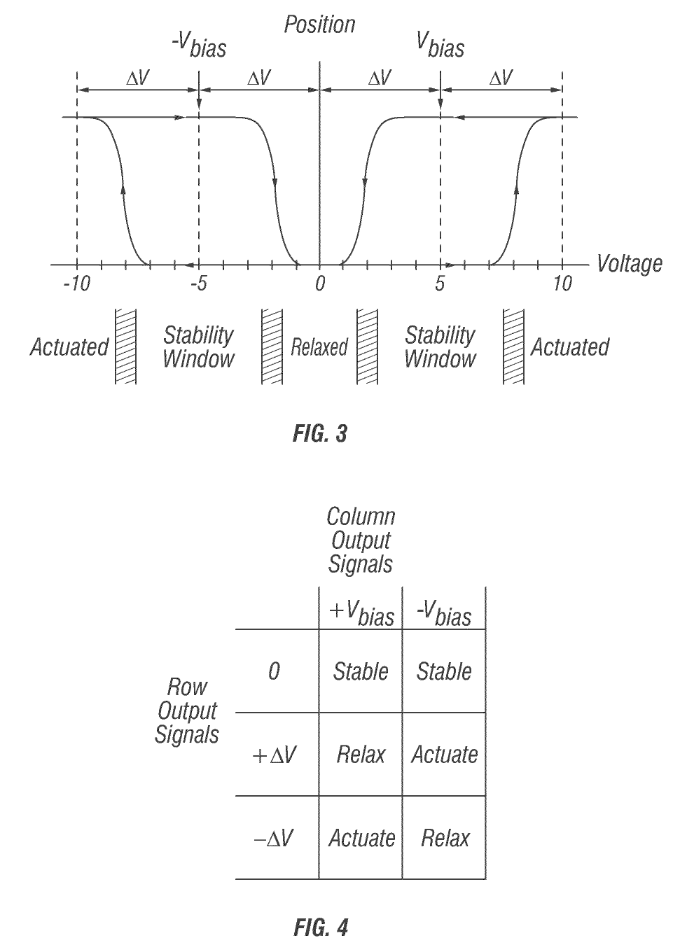

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

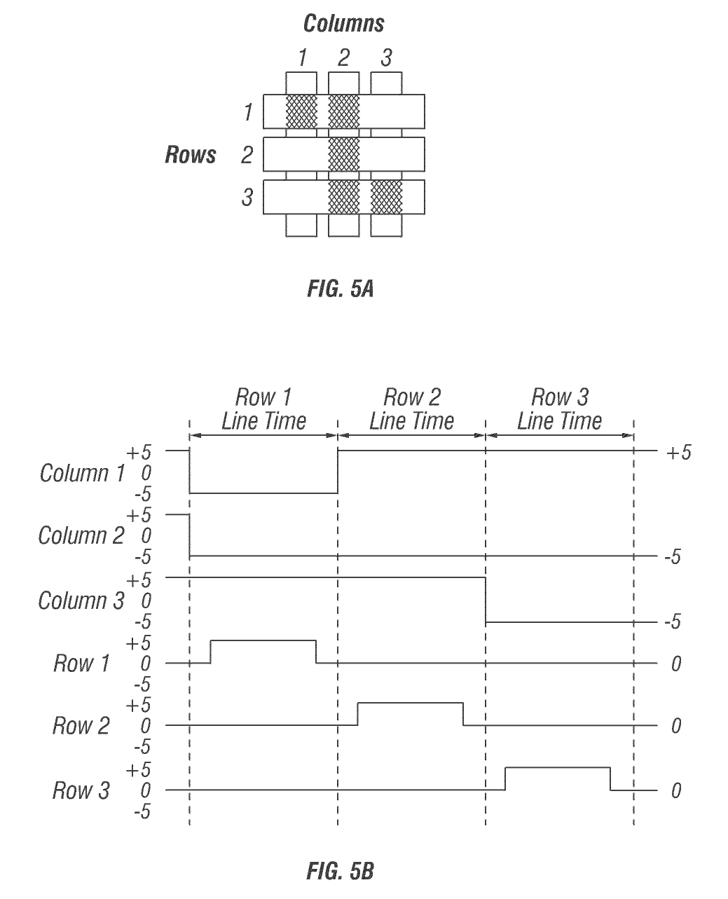

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

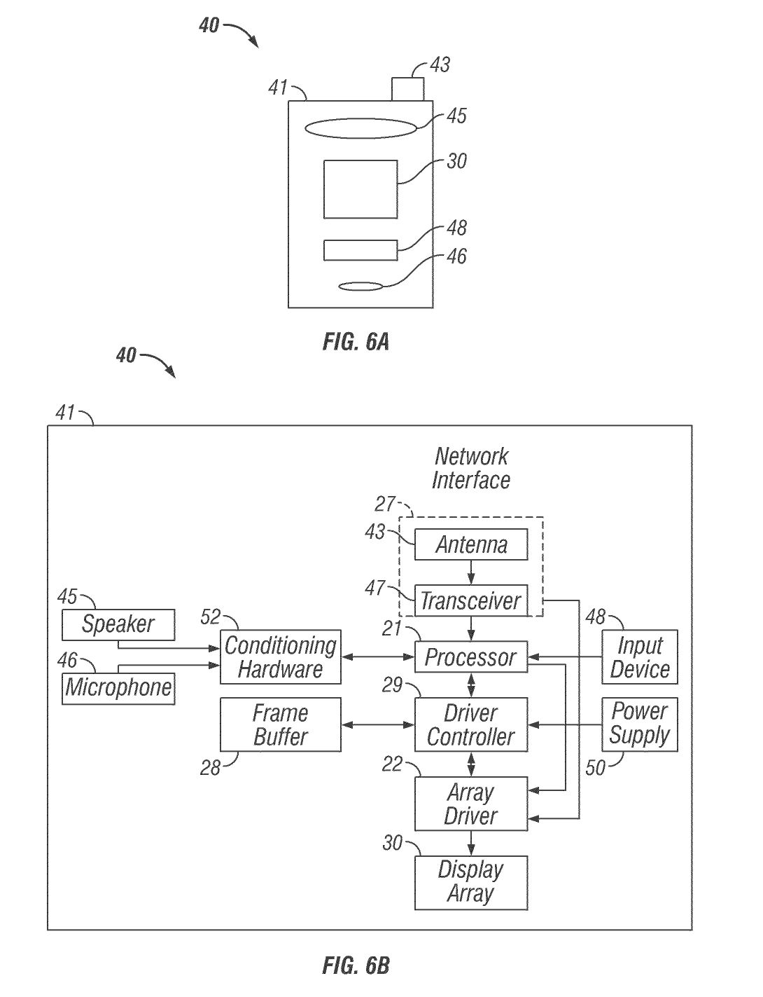

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

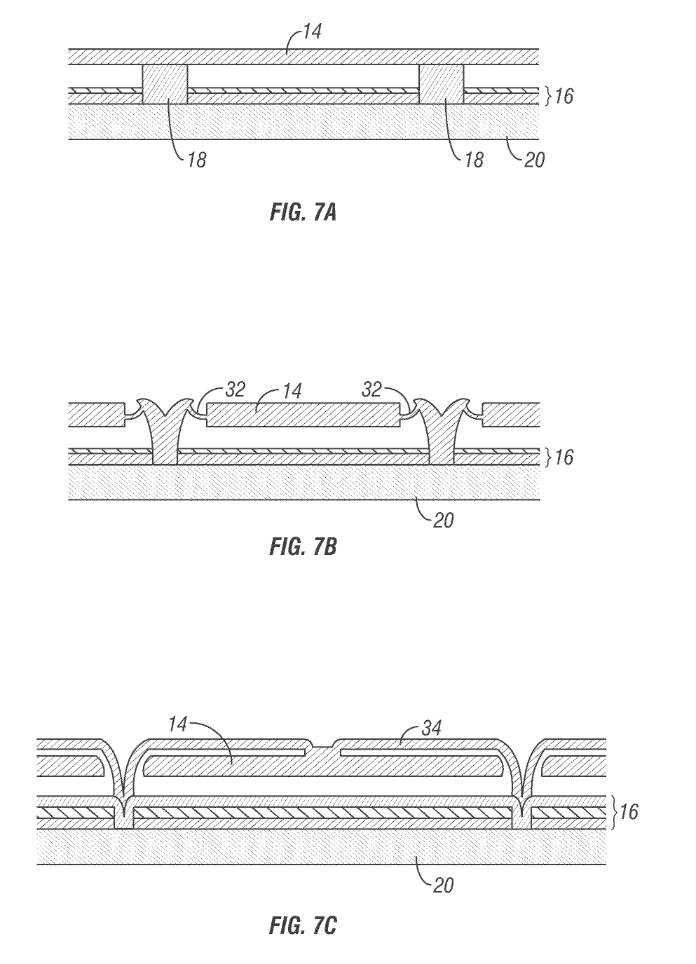

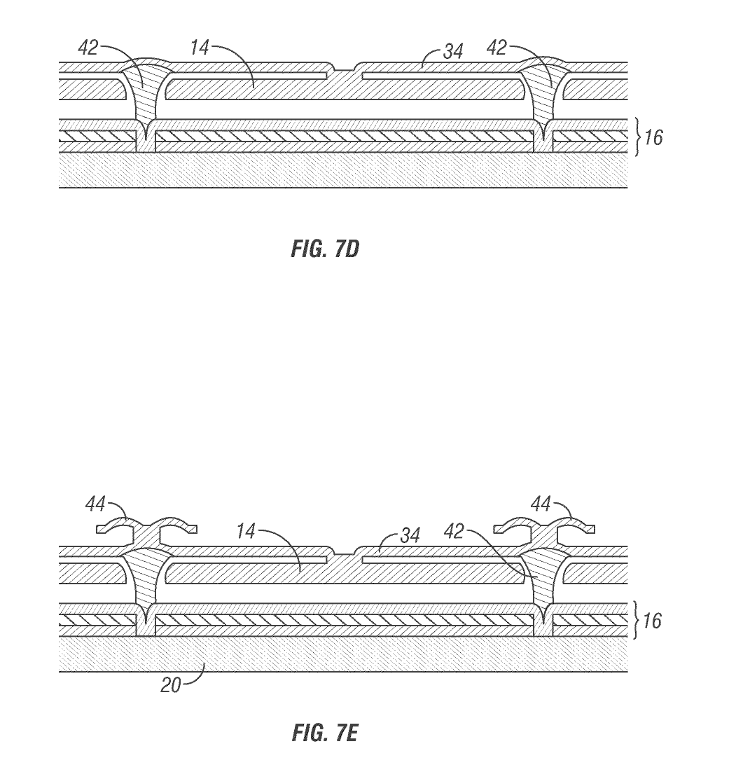

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

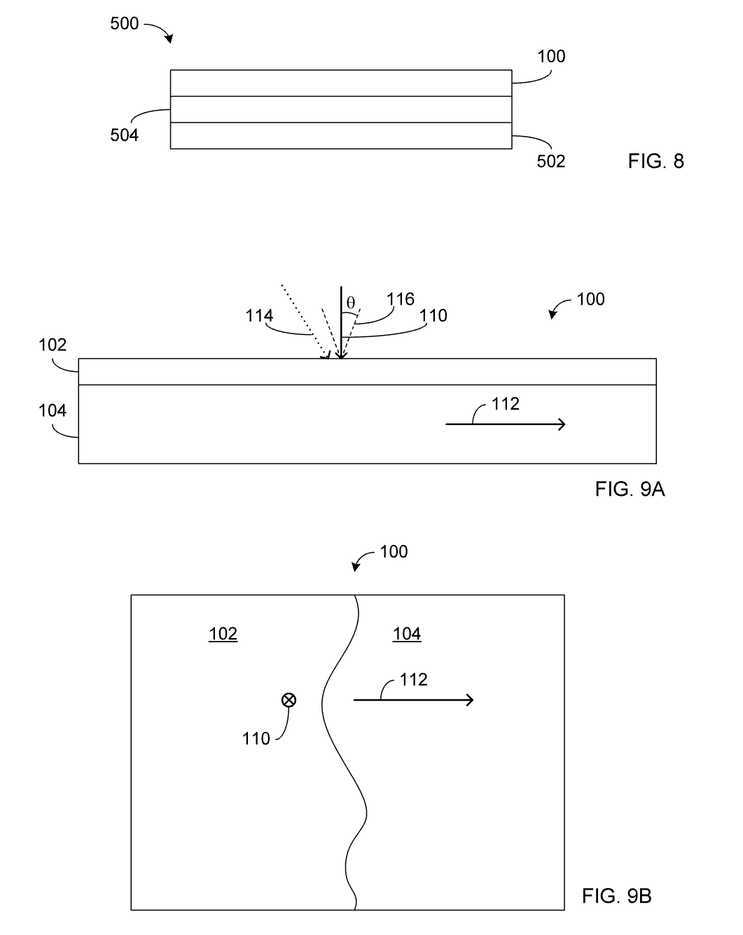

FIG. 8 shows that in certain embodiments, an interface device 500 can include a display device 502 and an input device 100. The interface device 500 can be part of electronic devices such as portable computing and/or communication devices to provide user interface functionalities.

In certain embodiments, the display device 502 can include one or more embodiments of various devices, methods, and functionalities as described herein in reference to FIGS. 1-7. Such devices can include various embodiments of interferometric modulators.

In certain embodiments, the input device 100 can be combined with the interferometric modulator based display device to form the interface device 500. As described herein, however, various features of the input device 100 do not necessarily require that the display device 502 be a device based on interferometric modulators. In certain embodiments, the display device 502 can be one of a number of display devices, such as a transreflective display device, an electronic ink display device, a plasma display device, an electro chromism display device, an electro wetting display device, a DLP display device, an electro luminescence display device. Other display devices can also be used.

FIG. 8 shows that in certain embodiments, an optical isolation region 504 can be provided between the display device 502 and the input device 100. In certain embodiments as described herein, the input device 100 can include a light guide that guides light that is selectively directed by a holographic layer. In such a configuration, the isolation region 504 can have a lower refractive index than the light guide. This low refractive index region may act as an optical isolation layer for the light guide. In such embodiments, the interface of light guide and low refractive index (n) layer forms a TIR (total internal reflection) interface. Light rays within the light guide which are incident on the interface at greater than the critical angle (e.g.,) 40°, as measured with respect to the normal to the surface, will be specularly reflected back into the light guide. The value of n can be less than the refractive index of the light guide, and may, for example be a layer of material such as a layer of glass or plastic. In certain embodiments, the low index region can include an air gap or a gap filled with another gas or liquid. Other materials may also be used. In various preferred embodiments, the material is substantially optically transparent such that the display device 502 may be viewed through the material.

In certain embodiments, the input device 100 of FIG. 8 can be configured to have one or more features disclosed herein, and can be implemented in interface devices such as a touchscreen. As generally known, a touchscreen allows a user to view and make selections directly on a screen by touching an appropriate portion of the screen. In one or more embodiments described herein, it will be understood that “touchscreen” or “touch screen” can include configurations where a user inputs may or may not involve physical contact between a touching object (such as a fingertip or a stylus) and a surface of a screen. As described herein, location of the “touching” object can be sensed with or without such physical contact.

In certain embodiments, a user interface such as a touchscreen can include a configuration 100 schematically depicted in FIGS. 9A and 9B, where FIG. 9A shows a side view and FIG. 9B shows a partially cutaway plan view. A holographic layer 102 is depicted as being disposed adjacent a light guide 104. Although the holographic layer 102 and the light guide 104 are depicted as being immediately adjacent to each other, it will be understood that the two layers may or may not be in direct contact. Preferably, the holographic layer 102 and the light guide 104 are coupled so as to allow efficient transmission of light.

In certain embodiments, the holographic layer 102 can be configured to accept incident light travelling within a selected range of incidence angle and transmit a substantial portion of the accepted light towards a selected range of transmitted direction in the light guide 104. For example, a light ray 110 is depicted as being within an example incidence acceptance range 116 and incident on the holographic layer 102. Thus, the ray 110 can be accepted and be directed as transmitted ray 112 in the light guide 104. Another example incident light ray 114 (dotted arrow) is depicted as being outside of the acceptance range 116; and thus is not transmitted to the light guide 104.

In certain embodiments, the incidence acceptance range (e.g., 116 in FIG. 9A) can be a cone about a normal line extending from a given location on the surface of the holographic layer 102. The cone can have an angle θ relative to the normal line, and θ can have a value in a range of, for example, approximately 0 to 15 degrees, approximately 0 to 10 degrees, approximately 0 to 5 degrees, approximately 0 to 2 degrees, or approximately 0 to 1 degree.

In certain embodiments, the incidence acceptance range does not need to be symmetric about the example normal line. For example, an asymmetric acceptance cone can be provided to accommodate any asymmetries associated with a given device and/or its typical usage.

In certain embodiments, the incidence acceptance range can be selected with respect to a reference other than the normal line. For example, a cone (symmetric or asymmetric) about a non-normal line extending from a given location on the surface of the holographic layer 102 can provide the incidence acceptance range. In certain situations, such angled acceptance cone can also accommodate any asymmetries associated with a given device and/or its typical usage.

In certain embodiments, the holographic layer 102 configured to provide one or more of the features described herein can include one or more volume or surface holograms. More generally, the holographic layer 102 may be referred to as diffractive optics, having for example diffractive features such as volume or surface features. In certain embodiments, the diffractive optics can include one or more holograms. The diffractive features in such embodiments can include holographic features.

Holography advantageously enables light to be manipulated so as to achieve a desired output for a given input. Moreover, multiple functions may be included in a single holographic layer. In certain embodiments, for instance, a first hologram comprising a first plurality of holographic features that provide for one function (e.g., turning light) and a second hologram comprising a second plurality of holographic features provide for another function (e.g. collimating light). Accordingly, the holographic layer 102 may include a set of volume index of refraction variations or topographical features arranged to diffract light in a specific manner, for example, to turn incident light into the light guide.

A holographic layer may be equivalently considered by one skilled in the art as including multiple holograms or as including a single hologram having for example multiple optical functions recorded therein. Accordingly, the term hologram may be used herein to describe diffractive optics in which one or more optical functions have been holographically recorded. Alternately, a single holographic layer may be described herein as having multiple holograms recorded therein each providing a single optical function such as, e.g., collimating light, etc.

In certain embodiments, the holographic layer 102 described herein can be a transmissive hologram. Although various examples herein are described in the context of a transmissive hologram, it will be understood that a reflective hologram can also be utilized in other embodiments.

The transmissive holographic layer can be configured to accept light within an angular range of acceptance relative to, for example, the normal of the holographic layer. The accepted light can then be directed at an angle relative to the holographic layer. For the purpose of description, such directed angle is also referred to as a diffraction angle. In certain embodiments, the diffraction angle can be between about 0 degrees to about 90 degrees (substantially perpendicular to the holographic layer).

In certain embodiments, light accepted by the hologram may be in a range of angles having an angular width of full width at half maximum (FWHM) between about 2° to 10°, about 10° to 20°, about 20° to 30°, about 30° to 40°, or about 40° to 50°. The light accepted by the hologram may be centered at an angle of about 0 to 5°, about 5° to10°, about 10° to 15°, about 15° to about 20°, or about 20° to 25° with respect to the normal to the holographic layer. In certain embodiments, light incident at other angles outside the range of acceptance angles can be transmitted through the holographic layer into angles determined by Snell's law of refraction. In certain embodiments, light incident at other angles outside the range of acceptance angles of the holographic layer can be reflected at an angle generally equal to the angle of incidence.

In some embodiments, the acceptance range may be centered at angles of about 0, about 5, about 10, about 15, about 20, about 25, about 30, about 35, about 40, about 45, about 50, about 55, about 60, about 65, about 70, about 75, about 80, or about 85 degrees, and may have a width (FWHM, for example) of about 1, about 2, about 4, about 5, about 7, about 10, about 15, about 20, about 25, about 30, about 35, about 40, or about 45 degrees. The efficiency of the hologram may vary for different embodiments. The efficiency of a hologram can be represented as the ratio of (a) light incident within the acceptance range which is redirected (e.g., turned) by the hologram as a result of optical interference caused by the holographic features to (b) the total light incident within the range of acceptance, and can be determined by the design and fabrication parameters of the hologram. In some embodiments, the efficiency is greater than about 1%, about 5%, about 10%, about 15%, about 20%, about 25%, about 30%, about 35%, about 40%, about 45%, about 50%, about 55%, 60%, about 65%, about 70%, about 75%, about 80%, about 85%, about 90%, or about 95%.

To provide for the different acceptance angles, multiple hologram of sets of holographic features may be recorded within the holographic layer. Such holograms or holographic features can be recorded by using beams directed at different angles.

For example, a holographic recording medium may be exposed to one set of beams to establish a reflection hologram. The holographic recording medium may additionally be exposed to a second set of beams to record a transmission hologram. The holographic recording medium may be developed such that the two holograms are formed, for example, in a single layer. In such an arrangement, two sets of holographic features, one corresponding to the reflection hologram and one corresponding to the transmission hologram are formed. One skilled in the art may refer to the aggregate structure as a single hologram or alternately as multiple holograms.

Optical or non-optical replication processes may be employed to generate additional holograms. For example, a master can be generated from the developed layer and the master can be used to produce similar holograms having the two sets of holographic features therein to provide the reflective and transmissive functionality. Intermediate structures may also be formed. For example, the original can be replicated one or more times before forming the master or product.

As described above, the replicated holographic structure may be referred to as a single hologram comprising multiple sets of holographic features that provide different functions. Alternatively, the sets of holographic features providing different functions can be referred to as different holograms.

The holographic features may comprise, for example, surface features or volume features of the holographic layer. Other methods can also be used. The holograms may for example be computer generated or formed from a master. The master may or may not be computer generated. In some embodiments, different methods or a combination of methods are used.

A wide variety of variation is possible. Films, layers, components, and/or elements may be added, removed, or rearranged. Additionally, processing steps may be added, removed, or reordered. Also, although the terms film and layer have been used herein, such terms as used herein include film stacks and multilayers. Such film stacks and multilayers may be adhered to other structures using adhesive or may be formed on other structures using deposition or in other manners. Similarly, as described above, sets of holographic features providing multiple functionality aspects may be integrated together in a single layer or in multiple layers. Multiple sets of holographic features included in a single layer to provide multiple functionality aspects may be referred to as a plurality of holograms or a single hologram.

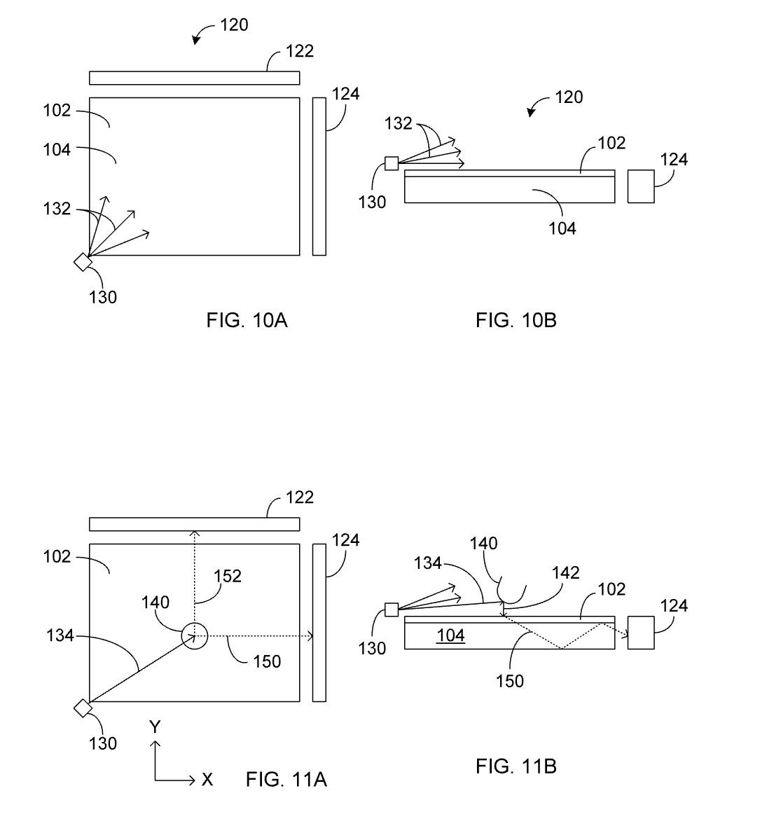

As illustrated in FIGS. 9A and 9B, certain light rays that are incident on the holographic layer 102 can be redirected into the light guide 104. In certain embodiments, such redirected light can be detected so as to allow determination of the incidence location on the holographic layer 102. FIGS. 10 and 11 show an example configuration of a touchscreen assembly 120 and its usage where incidence of light on the holographic layer 102 can be facilitated by reflection of light by an object 140 (such as a fingertip) near the holographic layer 102.

In certain embodiments, light rays (e.g., ray 110) that are incident on the holographic layer 102 can result from interaction of illumination light with an object proximate the holographic layer 102. For the purpose of description herein, such interaction between the illumination light and the object is described as reflection and/or scattering; and sometimes the two terms may be used interchangeably.

FIGS. 10A and 10B schematically depict plan and side views, respectively, of the touchscreen assembly 120. A light source 130 can be disposed relative to the holographic layer 102 so as to provide light rays 132 to a region adjacent the holographic layer 102 (e.g., above the holographic layer 102 if the assembly 120 is oriented as shown in FIG. 10B).

As shown in FIG. 11B, some of the light rays 132 can scatter from the fingertip 140 so as to yield an accepted incident ray (arrow 142) described in reference to FIGS. 9A and 9B. In certain embodiments, the light source 130 can be configured so that its light 132 fans out and provides illumination to substantially or all of the lateral region adjacent the holographic layer 102. The light source 130 can also be configured so as to limit the upward angle (assuming the example orientation of FIG. 10B) of the illumination light 132, so as to reduce the likelihood of an accepted incident light resulting from an object that is undesirably distant from the holographic layer 102.

In certain embodiments, the light source 130 can be configured so that its illumination light 132 is sufficiently distinguishable from ambient and/or background light. For example, an infrared light emitting diode (LED) can be utilized to distinguish the illumination light and the redirected light from ambient visible light. In certain embodiments, the light source 130 can be pulsed in a known manner to distinguish the illumination light from the background where infrared light is also present.

In FIG. 11B, the accepted incident ray 142 is depicted as being redirected to the right side, enter the light guide 104, and be propagated to the right as a guided ray 150. The guided ray 150 is further depicted as exiting the light guide 104 and detected by a detector 124.

In certain embodiments, the detector 124 can have an array of photo-detectors extending along a Y direction (assuming the example coordinate system shown in FIG. 11A) to allow determination of the exit location of the guided light 150. Thus, by knowing the redirecting properties of the holographic layer 102, Y value of the incidence location can be determined.

In certain embodiments, a similar detector 122 can be provided so as to allow determination of X value of the incidence location. In certain embodiments, the holographic layer 102 can be configured to provide redirection of accepted incident light into both X and Y directions.

In certain embodiments, holographic layer 102 can be configured so that the redirected light (e.g., 150 or 152 in FIG. 11A) propagates from the incidence location within a redirection range. In certain embodiments, the redirection range can be within an opening angle that is, for example, approximately 0 to 40 degrees, approximately 0 to 30 degrees, approximately 0 to 20 degrees, approximately 0 to 10 degrees, approximately 0 to 5 degrees, or approximately 0 to 2 degree. Thus, when the holographic layer 102 is aligned appropriately with the light guide 104 and the detectors 122, 124, the guided light can have similar direction range with respect to the XY plane.

In certain embodiments, the detectors 122 and 124 can be configured and disposed relative to the light guide 104 to allow detection of the corresponding guided light (152 and 150 in FIG. 11A) with sufficient resolution. For example, if the holographic layer 102 is capable of redirecting light into a relatively narrow range, the detector can be provided with sufficient segmentation to accommodate such resolution capability.

In the example detection configuration of FIGS. 10 and 11, the detectors 122 and 124 can be line sensor arrays positioned along the edges of the light guide (e.g., along X and Y directions). It will be understood that other configurations of detectors and/or their positions relative to the light guide are also possible.

In certain embodiments, for example, discrete sensing elements such as point-like sensors can be positioned at or near two or more corners of the light guide. Such sensors can detect light propagating from an incidence location; and the incidence location can be calculated based on, for example, intensities of light detected by the sensors. By way of an example, suppose that a point-like sensor is positioned at each of the four corners of a rectangular shaped light guide. Assuming that responses of the four sensors are normalized in some known manner, relative strengths of signals generated by the sensors can be used to calculate X and/or Y values of the incidence location. In certain embodiments, the foregoing detection configuration can be facilitated by a holographic layer that is configured to diffract incident light along a direction within a substantially full azimuthal range of about 0 to 360 degrees. Such a holographic layer can further be configured to diffract incident light along a polar direction within some range (e.g., approximately 0 to 40 degrees) of an opening angle.

In certain embodiments, the forgoing sensors placed at the corners of the light guide can be positioned above, below, or at generally same level as the light guide. For example, to accommodate configurations where the sensors are below the light guide (on the opposite side from the incidence side), a holographic layer can be configured to diffract an incident ray into the light guide such that the ray exits the opposite side of the light guide at a large angle (relative to the normal) and propagate towards the sensors. Such a large exit angle relative to the normal can be achieved by, for example, having the diffracted ray's polar angle be slightly less than the critical angle of the interface between the light guide and the medium below the light guide. If the light guide is formed from glass and air is below the light guide, the ray's polar angle can be selected to be slightly less than about 42 degrees (critical angle for glass-air interface) so as to yield a transmitted ray that propagates in the air nearly parallel to the surface of the light guide.

As described herein, the light source 130 can be configured so that its illumination light 132 is distinguishable from ambient and/or background light. In certain embodiments, the detectors 122 and 124 can also be configured provide such distinguishing capabilities. For example, one or more appropriate filters (e.g., selective wavelength filter(s)) can be provided to filter out undesirable ambient and/or background light.

Based on the foregoing, location of the fingertip touching or in close proximity to the holographic layer can be determined, thereby providing a user interface functionality. Because such location determination is by optical detection and does not rely on physical pressure of the fingertip on the screen, problems associated with touchscreens relying on physical contacts can be avoided.

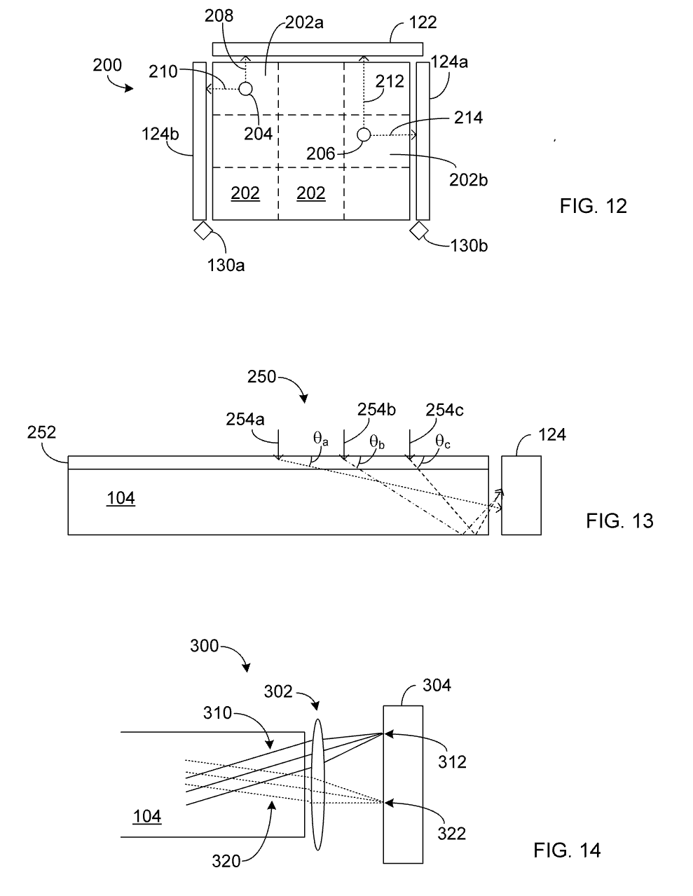

FIGS. 12-16 show non-limiting examples of variations that can be implemented to facilitate various user interface situations. In FIG. 12, an example configuration 200 is shown where two or more user inputs can be accommodated. For example, suppose that a user is using a handheld computing device with two fingers (such as two thumbs). In certain embodiments, a holographic layer can be configured to have a plurality of regions 202 where light redirecting properties are different. A first example region 202a is depicted as being configured to redirect incident light reflected from a first object 204 (e.g., left thumb) towards negative X direction (arrow 210) and positive Y direction (arrow 208). A second example region 202b is depicted as being configured to redirect incident light from a second object 206 (e.g., right thumb) towards positive X direction (arrow 214) and positive Y direction (arrow 212).

To accommodate detection of such two or more incident rays on the holographic layer, one or more additional detectors can be provided. For example, an additional detector 124b can be provided to allow capture and detection of light redirected towards the negative X direction (such as arrow 210), while the detector 124a captures and detects light redirected towards the positive X direction.

Thus, ambiguities associated with detection of two or more light incidence locations can be reduced or removed by separate detectors and/or an appropriate algorithm controlling a given detector. For example, the example detector 122 is depicted as capturing and detecting light redirected towards the positive Y direction. The detector 122 can be controlled by an algorithm that associates a region on the holographic layer with a signal obtained from the detector. A signal resulting from redirected light 208 can be associated with a detection element having an X value; and a signal resulting from redirected light 212 can be associated with another detection element having another X value. Thus, the algorithm can be configured to distinguish the two signals—and thus the two regions 202a and 202b with respect to the X direction—based on the different X values of the two detection elements.

In certain situations, presence of two or more objects on or near the surface of the holographic layer may result in one object casting a shadow to another object. For example, if there is only one light source, then a first object between the light source and a second object may result in the first object casting a shadow to the second object. Consequently, the second object may not be able to effectively reflect the illumination light at its location.

To alleviate such concerns, the example configuration 200 of FIG. 12 shows that one or more additional light sources (e.g., a second light source 130b) can be provided. In the example shown, the second light source 130b can be disposed at a different location than the first light source 130a. Thus, light from the second light source 130b can effectively illuminate the second object 206 even if the first object 204 happens to be positioned to cast a shadow from the first light source 130a.

In certain embodiments, each of the two or more light sources can be configured to provide detectable distinguishing features so as to further reduce likelihood of ambiguities. For example, light from the sources can be modulated in different patterns and/or frequencies.

As described herein in reference to FIG. 12, lateral direction of redirected light can be made to depend on the lateral location of incidence. In certain embodiments, directionality of the redirected light can depend on where a given region 202 is located. For example, the region 202a is depicted as being configured to provide −X and +Y directionality for light incident thereon. In another example, the region 202b is depicted as being configured to provide +X and +Y directionality for light incident thereon. In certain embodiments, assignment of such directionality for a given region can be based at least in part on proximity of the region to one or more light sources and/or one or more detectors. In the foregoing examples, the region 202a is closer to the detector 124b so that its directionality can be assigned towards that detector 124b; and the region 202b is closer to the detector 124a so that its directionality can be assigned towards that detector 124a. In situations where a given region can be assigned either way based on proximity (e.g., a region located about halfway between two detectors), a rule can be implemented to assign the region to one of the detectors.

In FIG. 13, an example configuration 250 is shown where a holographic layer 252 can be configured to provide diffraction angle θ that depends on the incidence location. By way of examples, a number of rays 254 are shown to be incident (e.g., normal incidence) on the holographic layer 252. A first example ray 254a is shown to be diffracted by the holographic layer 252 at a first angle of θₐ; a second ray 254b by a second angle θ_{b}); and a third ray 254c by a third angle θ_{c}.

In certain embodiments, such location-dependent diffraction angle can be provided to facilitate one or more design criteria. By way of a non-limiting example, suppose that there is a preference to reduce the number of total internal reflections that a given redirected ray undergoes in the light guide 104. For such a design, diffraction angle θ can be made to progressively decrease as incidence location's distance (from light guide exit) increases. Thus, in the example configuration 250 shown in FIG. 13, the first angle θₐ can be less than the second angle θ_{b}, which in turn can be less than the third angle θ_{c}. Accordingly, redirected ray from the first incident ray 254a is depicted as exiting the light guide 104 without undergoing total internal reflection. Similarly, redirected rays from the first and second incident rays 254b and 254c are depicted as undergoing one total internal reflection each before exiting the light guide 104.

In the non-limiting examples described in reference to FIGS. 12 and 13, various functionalities depend on lateral (X and/or Y) position of incident light. In certain embodiments, Z-dependent features and/or information can be implemented and/or obtained in one or more components of the touchscreen assembly. For the purpose of description, Z-direction is sometimes referred to as “vertical” direction, in the context of the example coordinate system of FIG. 11A.

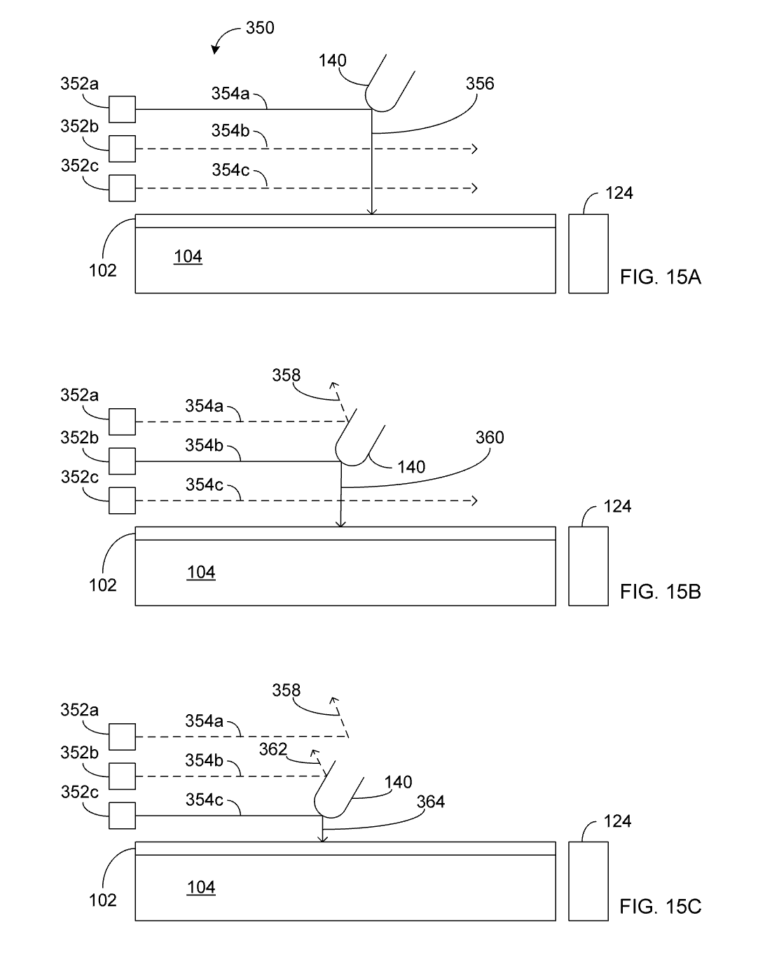

In certain embodiments, one or more of such vertical components can be implemented and/or obtained at different portions of the touchscreen assembly. FIG. 14 shows a non-limiting example where vertical component of redirected light can be considered. FIGS. 15-17 show non-limiting examples where vertical component of inputs can be considered.

In certain operating configurations, light propagating through a light guide can have spatial information encoded in its angular distribution. Vertical direction of a redirected ray exiting the light guide can facilitate determination of at least some of such spatial information.

FIG. 14 shows a side view of an example configuration 300 where redirected rays 310 and 320 are exiting a light guide 104. The first example ray 310 is shown to have an upward angle, and the second example ray 320 is shown to have a downward angle.

In certain embodiments, an optical element such as a hologram or a lens can be place adjacent the exit location of the light guide 104 to obtain vertical information for exiting rays. For example, a lens 302 can be provided so as to focus and better resolve such rays (310, 320) by a detector 304. Focal points 312 and 322 are depicted on the detector 304.

In certain embodiments, the detector 304 can include segmentation along the Z-direction. In certain embodiments, light propagating to the edge of the light guide can contain spatial information encoded in its angular distribution. A two-dimensional sensor array can be used for the detector 304 so as to allow conversion of the angular information back into the spatial information. Such spatial information can facilitate, for example, more distinguishable multi-touch events (e.g., two or more touches).

In certain embodiments, the touchscreen assembly can be configured to obtain vertical information about an input-inducing object (such as a fingertip). Combined with various features that allow lateral position determination, such vertical information can facilitate three-dimensional position determination for the input-inducing object.

FIGS. 15A-15C show various positions of a fingertip 140 relative to a touchscreen assembly 350. Such sequence of positions can correspond to a fingertip moving towards a target location on a holographic layer. As shown, the example assembly 350 can include a plurality of light sources 352 disposed and configured so as to emit light at different vertical locations relative to a holographic layer 102. For the purpose of description, three of such light sources (352a, 352b, 352c) are depicted; however, it will be understood that number of such light sources can be more or less than three.

In FIG. 15A, the fingertip 140 is depicted as reflecting a first source ray 354a from a first light source 352a so as to yield a first incident ray 356. Source rays (354b and 354c) from the other light sources (352b and 352c) are depicted as bypassing the fingertip 140, and thus not yielding incident rays. The first incident ray 356 can be accepted and redirected by the holographic layer 102 as described herein. Thus, detection of the incident ray 356 can provide lateral position information as well vertical information by virtue of the vertical position of the first source ray 354a.

In FIG. 15B, the fingertip 140 is depicted as reflecting a second source ray 354b from a second light source 352b so as to yield a second incident ray 360. Source rays (354a and 354c) from the other light sources (352a and 352c) are depicted as either being reflected away (ray 358) by the fingertip 140 or bypassing the fingertip 140, and thus not yielding incident rays. The second incident ray 360 can be accepted and redirected by the holographic layer 102 as described herein. Thus, detection of the incident ray 360 can provide lateral position information as well vertical information by virtue of the vertical position of the first source ray 354b.

In FIG. 15C, the fingertip 140 is depicted as reflecting a third source ray 354c from a third light source 352c so as to yield a third incident ray 364. Source rays (354a and 354b) from the other light sources (352a and 352b) are depicted as being reflected away (rays 358 and 362) by the fingertip 140, and thus not yielding incident rays. The third incident ray 364 can be accepted and redirected by the holographic layer 102 as described herein. Thus, detection of the incident ray 364 can provide lateral position information as well vertical information by virtue of the vertical position of the first source ray 354c.

In certain embodiments, the light sources 352 can include separate light sources. In certain embodiments, the light sources 352 can include a configuration where two or more light output devices share a common source where light from such a common source is provided via the output devices.

In certain embodiments, light from each of the light sources 352 can be substantially collimated or quasi-collimated so as to generally form a sheet or layer of illumination. Such collimation or quasi-collimation can be achieved via a number of known techniques. For example, lenses, reflectors, and/or apertures can be used alone or in combination in known manners to yield a given sheet of light that is sufficiently defined with respect to its neighboring sheet.

In addition to the different vertical positions of the light sources, in certain embodiments, light from each of the sources can be detectably distinguishable from light from other source(s). For example, the light sources 352 can include light emitting diodes (LEDs) operating at different wavelength and/or modulated in different patterns and/or frequencies. For the foregoing example where a common light source is utilized, the light output devices can be configured (e.g., with different color filters) to yield distinguishable outputs.

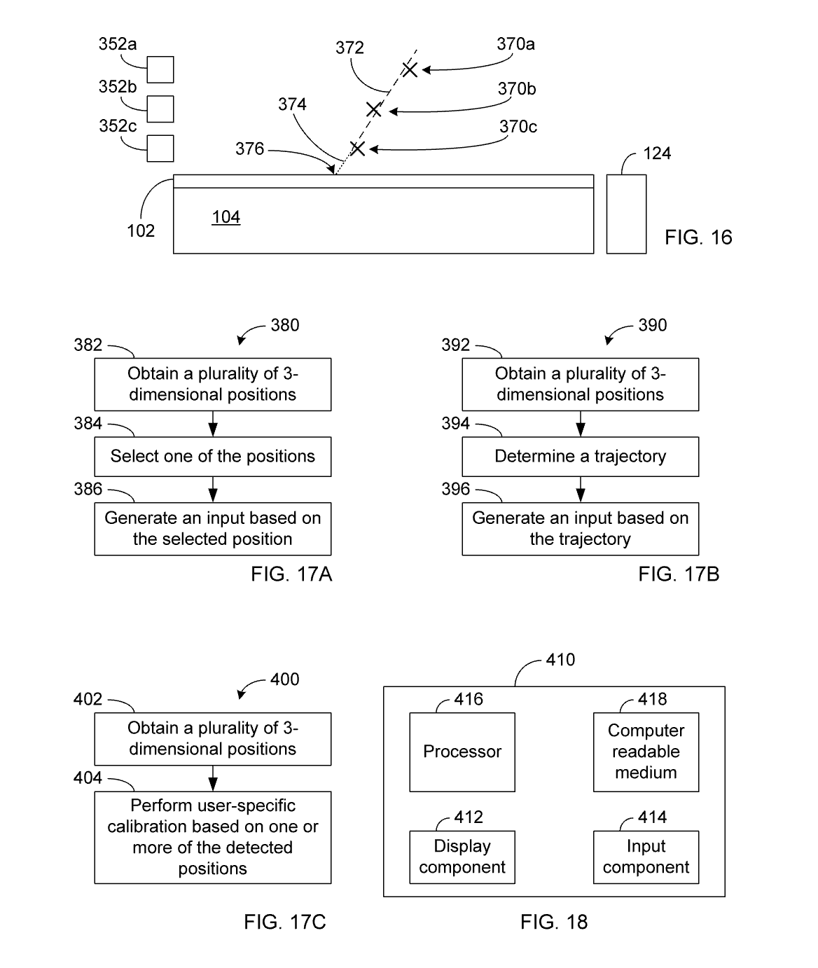

FIG. 16 shows a depiction of a plurality of three-dimensional fingertip positions (370a, 370b, 370c) determined as described in reference to FIGS. 15A-15C. In certain embodiments, one or more of such detected three-dimensional positions can be utilized to form an input for an electronic device. FIGS. 17A-17C show non-limiting examples of how such inputs can be generated.

FIG. 17A shows an example process 380 that can be implemented to generate an input for an electronic device. In a process block 382, a plurality of three-dimensional positions can be obtained. In a process block 384, one of the plurality of positions can be selected. In a process block 386, an input for the electronic device can be generated based on the selected position information.

In certain embodiments, the foregoing example of input generation can provide flexibility in how a touchscreen is configured and used. In certain situations, it may be desirable to base an input on the vertical position closest to the touchscreen surface; whereas in other situations, use of detected vertical positions further away may be desirable.

FIG. 17B shows an example process 390 that can be implemented to generate an input for an electronic device. In a process block 392, a plurality of three-dimensional positions can be obtained. In a process block 394, a trajectory of a reflecting object (e.g., fingertip) can be determined based on the positions. In FIG. 16, dashed line 372 depicts a trajectory representative of the example detected positions 370. Such trajectory can be obtained in a number of known ways (e.g., curve fitting), and may or may not be a straight line. In a process block 396, an input for the electronic device can be generated based on the trajectory. In FIG. 16, for example, an extrapolation of the trajectory 372 is depicted as a dotted line 374 that intersects with the surface of the holographic layer 102 at location 376. In certain embodiments, the input generated in process block 396 can be based on the projected location 376.

The example trajectory 372 in FIG. 16 is depicted as being at an angle relative to the holographic layer's normal line. In certain situations, different users may have different preferences or habits when using touchscreen based devices. For example, direction and/or manner of approaching a touchscreen may differ significantly.

In certain embodiments, such user-specific differences and/or preferences can be accommodated by a calibration routine 400 as shown in FIG. 17C. In a process block 402, a plurality of three-dimensional positions can be obtained. In a process block 404, a user-specific calibration can be performed based on one or more of the detected positions.

FIG. 18 shows that in certain embodiments, one or more features of the present disclosure can be implemented via and/or facilitated by a system 410 having different components. In certain embodiments, the system 410 can be implemented in electronic devices such as portable computing and/or communication devices.

In certain embodiments, the system 410 can include a display component 412 and an input component 414. The display and input components (412, 414) can be embodied as the display and input devices 502 and 100 (FIG. 8), and be configured to provide various functionalities as described herein.

In certain embodiments, a processor 416 can be configured to perform and/or facilitate one or more of processes as described herein. In certain embodiments, a computer readable medium 418 can be provided so as to facilitate various functionalities provided by the processor 416.

In one or more example embodiments, the functions, methods, algorithms, techniques, and components described herein may be implemented in hardware, software, firmware (e.g., including code segments), or any combination thereof. If implemented in software, the functions may be stored on or transmitted over as one or more instructions or code on a computer-readable medium. Tables, data structures, formulas, and so forth may be stored on a computer-readable medium. Computer-readable media include both computer storage media and communication media including any medium that facilitates transfer of a computer program from one place to another. A storage medium may be any available medium that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, one or more processing units at a transmitter and/or a receiver may be implemented within one or more computing devices including, but not limited to, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a software implementation, the techniques described herein may be implemented with code segments (e.g., modules) that perform the functions described herein. The software codes may be stored in memory units and executed by processors. The memory unit may be implemented within the processor or external to the processor, in which case it can be communicatively coupled to the processor via various means as is known in the art. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Components may be added, removed, or rearranged; and method steps may be added, removed, or reordered. Consequently, the scope of the invention should not be limited to the foregoing description, but should be defined by the appended claims.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

1. A screen assembly for an electronic device, the screen assembly comprising:
a display device configured to display an image by providing signals to selected locations of the display device;
an input device disposed adjacent the display device and configured to detect location of an input, the input location coordinated with the image on the display device so as to facilitate user interaction with the electronic device, the input device comprising a holographic layer configured to receive incident light and direct the incident light towards one or more selected directions; and
a detector configured to detect the directed light, detection of the directed light along the one or more selected directions allowing determination of incidence location on the holographic layer of the incident light.

2. The screen assembly of claim 1, further comprising one or more light sources configured to provide light to an object positioned on or near the holographic layer, at least a portion of the provided light scattering from the object to yield the incident light on the holographic layer.

3. The screen assembly of claim 2, wherein the one or more light sources are configured to provide one or more layers of collimated light, each layer of collimated light generally parallel with and at a distance from the holographic layer, the distance and the incidence location providing information representative of three-dimensional position of the object relative to the holographic layer.

4. The screen assembly of claim 2, wherein the one or more light sources are configured such that the provided light is distinguishable from ambient light when detected by the detector.

5. The screen assembly of claim 2, wherein the one or more light sources comprise at least two light sources arranged so as to reduce a shadow formed by the object when illuminated by one of the at least two light sources.

6. The screen assembly of claim 1, wherein the one or more selected directions comprise a component along a first lateral direction relative to the holographic layer.

7. The screen assembly of claim 6, wherein the one or more selected directions further comprise a component along a second lateral direction relative to the holographic layer, the second lateral direction substantially perpendicular to the first lateral direction.

8. The screen assembly of claim 7, wherein the detector comprised one or more arrays of detecting elements disposed so as to detect the directed light along the first and second lateral directions to allow determination of information representative of two-dimensional position of the incidence location.

9. The screen assembly of claim 1, wherein the holographic layer comprises two or more regions, at least some of the two or more regions having differences in the one or more selected directions of the directed light.

10. The screen assembly of claim 9, wherein the at least some of the two or more regions are configured such that one or more lateral components of the one or more selected directions of the directed light are different, the lateral components relative to the holographic layer.

11. The screen assembly of claim 9, wherein the screen assembly is configured to facilitate detection of more than one incidence locations based on the different configurations of the at least some of the two or more regions of the holographic layer.

12. The screen assembly of claim 9, wherein the at least some of the two or more regions are configured such that diffraction angles of the direct light are different, the diffraction angle being relative to the holographic layer.

13. The screen assembly of claim 12, wherein the holographic layer is configured so that the diffraction angle increases as the incidence location moves towards a periphery of the holographic layer.

14. The screen assembly of claim 1, further comprising a light guide disposed relative to the holographic layer so as to receive the directed light from the holographic layer and guide the directed light for at least a portion of the directed light's optical path to the detector.

15. The screen assembly of claim 14, wherein the light guide comprises a rectangular shaped slab so as to allow the directed light to exit through one or more edges of the slab.

16. The screen assembly of claim 15, wherein the detector is disposed relative to the slab so as to capture the directed light exiting through the one or more edges.

17. The screen assembly of claim 16, wherein the detector is configured to detect an exit angle of the directed light, the exit angle relative to a plane defined by the slab.

18. The screen assembly of claim 17, wherein the detector comprises a two-dimensional array of detecting elements.

19. The screen assembly of claim 18, further comprising a lens disposed between an edge of the slab and the detector to focus the exiting light on the detector.

20. The screen assembly of claim 1, further comprising an optical isolation region disposed between the display device and the input device.

21. A touchscreen apparatus, comprising:
a holographic layer configured to receive incident light and direct the incident light towards a selected direction;
a light guide disposed relative to the holographic layer so as to receive the directed light from the holographic layer and guide the directed light towards an exit portion of the light guide; and
a segmented detector disposed relative to the light guide so as to be able to detect the directed light exiting from the exit portion so as to facilitate determination of a location of the incident light along at least one lateral direction on the holographic layer.

22. The apparatus of claim 21, further comprising a light source disposed relative to the holographic layer and configured to provide light to an object positioned on or near the holographic layer, at least a portion of the provided light scattering from the object to yield the incident light on the holographic layer.

23. The apparatus of claim 22, further comprising:
a display;
a processor that is configured to communicate with the display, the processor being configured to process image data; and
a memory device that is configured to communicate with the processor.

24. The apparatus of claim 23, wherein the display comprises a plurality of interferometric modulators.

25. A method for fabricating a touchscreen, the method comprising:
forming a diffraction pattern in or on a substrate layer defining a plane and having first and second sides, the diffraction pattern configured such that a light ray incident at a selected angle on the first side of the substrate layer is diffracted into a turned ray that exits on the second side of the substrate layer along a direction having a selected lateral component parallel with the plane of the substrate layer; and
coupling the substrate layer with a light guide layer that defines a plane substantially parallel to the plane of the substrate layer, the light guide layer being on the second side of the substrate layer and configured to received the turned light exiting from the substrate layer and guide the turned light substantially along the direction.

26. The method of claim 25, wherein the diffraction pattern comprises one or more volume or surface holograms formed in or on the substrate layer.

27. The method of claim 26, wherein the one or more holograms are configured such that the incident light ray selected angle is within an acceptance cone that opens from a vertex on or near the first side of the substrate layer.

28. The method of claim 26, wherein the one or more holograms are configured such that the direction of the turned ray is within a range of angles about a first lateral direction on the plane of the substrate layer.

29. An apparatus comprising:
means for displaying an image on a display device by providing signals to selected locations of the display device; and
means for detecting a location of an input on a screen, the input location coordinated with the image on the display device, the input resulting from positioning of an object at one or more levels above the screen such that light scattered from the object enters the screen at the location.

30. The apparatus of claim 29, further comprising means for providing the light at the one or more levels above the screen.
